(19) United States
(12) Patent Application Publication
(10) Pub. No.: US 2007/0233503 A1
(43) Pub. Date: Oct. 4, 2007

(54) Bidding for on-line survey placement

(76) Inventors: Michael M. Meyer, Seattle, WA (US); Ellen Konar, Palo Alto, CA (US)

Correspondence Address: HARRITY SNYDER, LLP, 11350 Random Hills Road, SUITE 600, FAIRFAX, VA, 22030, US

(21) Appl. No.: 11/394,193

(22) Filed: Mar. 31, 2006

(51) Int. Cl. G06Q 10/00; G07G 1/00; G06Q 30/00

(52) U.S. Cl. 705/1; 705/10

(57) ABSTRACT

A system receives bids associated with placement of respective surveys. The system selects one or more of the surveys based on their respective bids and associates the selected one or more surveys with documents hosted at one or more servers.

### BACKGROUND

1. Field of the Invention

Implementations described herein relate generally to surveys and, more particularly, to bidding for placement of on-line surveys.

2. Description of Related Art

The World Wide Web (“web”) contains a vast amount of information. Locating a desired portion of the information, however, can be challenging. This problem is compounded because the amount of information on the web and the number of new users inexperienced at web searching are growing rapidly.

Search engines attempt to return hyperlinks to web pages in which a user is interested. Generally, search engines base their determination of the user's interest on search terms (called a search query) entered by the user. The goal of the search engine is to provide links to high quality, relevant results (e.g., web pages) to the user based on the search query. Typically, the search engine accomplishes this by matching the terms in the search query to a corpus of pre-stored web pages. Web pages that contain the user's search terms are “hits” and are returned to the user as links. Each “hit” may be ranked by the search engine based on various factors, such as, for example, the relevance of the “hit” to the search query.

Existing search engines (e.g., Google Web search) may also include on-line advertising functionality that may advertise various services and/or products in conjunction with providing search results to users. Such advertisements may be presented to users accessing search results provided by the search engine. An advertisement may include a “creative,” which includes text, graphics and/or images associated with the advertised service and/or product. The advertisement may further include a link to an ad “landing document” which contains further details about the advertised service(s) and/or product(s). When a particular creative appears to be of interest to a user, the user may select (or click) the creative, and the associated link causes a user's web browser to visit the “landing document” associated with the creative and link. This selection of an advertising creative and associated link by a user is referred to hereinafter as a “click.”

### SUMMARY

According to one aspect, a computer-implemented method may include receiving bids associated with placement of respective surveys. The method may further include selecting one or more of the surveys based on their respective bids and associating the selected one or more surveys with documents hosted at one or more servers.

According to another aspect, a method may include receiving keywords or content associated with a document and receiving bids, and survey data, associated with placement of respective surveys. The method may further include selecting a set of the surveys by matching the survey data with the keywords or content associated with the document. The method may also include selecting one or more surveys from the set of surveys based on respective bids and associating the selected one or more surveys with the document.

According to a further aspect, a method may include receiving a search query and obtaining advertisements that match the search query. The method may further include receiving bids associated with placement of surveys and selecting one or more of the surveys based on their respective bids and the search query. The method may also include associating the selected one or more surveys with a document that includes the advertisements.

According to yet another aspect, a method may include hosting a plurality of surveys at a server from a plurality of different entities and providing one or more of the surveys to users via a network. The method may further include receiving survey result data from the users via the network and aggregating the survey result data.

### BRIEF DESCRIPTION OF THE DRAWINGS

The accompanying drawings, which are incorporated in and constitute a part of this specification, illustrate one or more embodiments of the invention and, together with the description, explain the invention. In the drawings,

FIG. 1 is an exemplary diagram of an overview of an implementation of the invention;

FIG. 2 is an exemplary diagram of a network in which systems and methods consistent with principles of the invention may be implemented;

FIG. 3 is an exemplary diagram of a client or server of FIG. 2 according to an implementation consistent with principles of the invention;

FIG. 4 is a flowchart of an exemplary process for associating surveys with documents based on survey placement bids consistent with principles of the invention;

FIG. 5 is a diagram that graphically illustrates the exemplary process of FIG. 4;

FIG. 6 is a diagram of an exemplary document for entering survey placement bids consistent with principles of the invention;

FIG. 7 is a flowchart of an exemplary process for associating surveys with documents based on survey placement bids and based on content of the respective surveys consistent with principles of the invention;

FIG. 8 is a diagram that graphically illustrates the exemplary process of FIG. 7;

FIG. 9 is a flowchart of an exemplary process for associating surveys with documents that include search results and/or advertisements based on survey placement bids consistent with principles of the invention;

FIG. 10 is a diagram that graphically illustrates the exemplary process of FIG. 9;

FIG. 11 is a diagram of an exemplary document that includes search results, advertisements, and a link to a hosted survey consistent with principles of the invention;

FIG. 12 is a diagram of an exemplary process for providing hosted surveys to users and aggregating the results of those surveys consistent with principles of the invention;

FIG. 13 is a diagram that graphically illustrates the exemplary process of FIG. 12;

FIG. 14 is a diagram of an exemplary implementation in which links to documents containing a survey are placed in a document;

FIG. 15 is a diagram of an exemplary implementation in which a survey document includes a link to an associated advertiser; and

FIG. 16 is a diagram of an exemplary implementation in which a user is directed to a reward document from a survey document when the user completes the survey contained in the survey document.

### DETAILED DESCRIPTION

The following detailed description of the invention refers to the accompanying drawings. The same reference numbers in different drawings may identify the same or similar elements. Also, the following detailed description does not limit the invention.

Advertisers and marketing groups are very interested in consumer feedback about their brands, products and/or services. For example, it is common for a marketing group to want to know about consumer sentiment for their brand. A direct way of assessing such sentiment (and any other question) is to ask the consumer or user. Commonly, off-line surveys and focus groups are used to answer such questions. A survey host may, consistent with aspects of the invention, host multiple on-line surveys, that may pose questions regarding particular brands, products and/or services, web sites, or user demographics, that can be accessed by users via a network. Multiple users or entities may, consistent with aspects of the invention, electronically bid to have their surveys placed by a survey host. The survey host may host surveys itself, or may place the surveys in documents hosted by other servers.

A “document,” as the term is used herein, is to be broadly interpreted to include any machine-readable and machine-storable work product. A document may include, for example, an e-mail, a website, a business listing, a file, a combination of files, one or more files with embedded links to other files, a news group posting, a blog, a web advertisement, a digital map, etc. In the context of the Internet, a common document is a web page. Documents often include textual information and may include embedded information (such as meta information, images, hyperlinks, etc.) and/or embedded instructions (such as Javascript, etc.). A “link,” as the term is used herein, is to be broadly interpreted to include any reference to/from a document from/to another document or another part of the same document.

A “survey,” as the term is used herein, may be broadly interpreted to include any series of questions, either related or unrelated, that may be posed by an entity, such as, for example, an individual, a business (e.g., an advertiser) or a governmental or non-profit organization. The entity may desire users to provide answers to the survey questions for purposes, such as, for example, marketing, product development, service enhancements, etc. A survey may include a series of related questions inquiring about a customer's satisfaction with respect to a product or service in question. A survey may further include a series of related questions inquiring about what a user liked or didn't like about an advertisement (i.e., an ad-effectiveness survey). A survey may also include a series of questions directed at a specific demographic, where the demographic is either self-identified or determined by other means. A survey may additionally include any combination of customer satisfaction, ad-effectiveness, demographic or other types of surveys.

### Overview

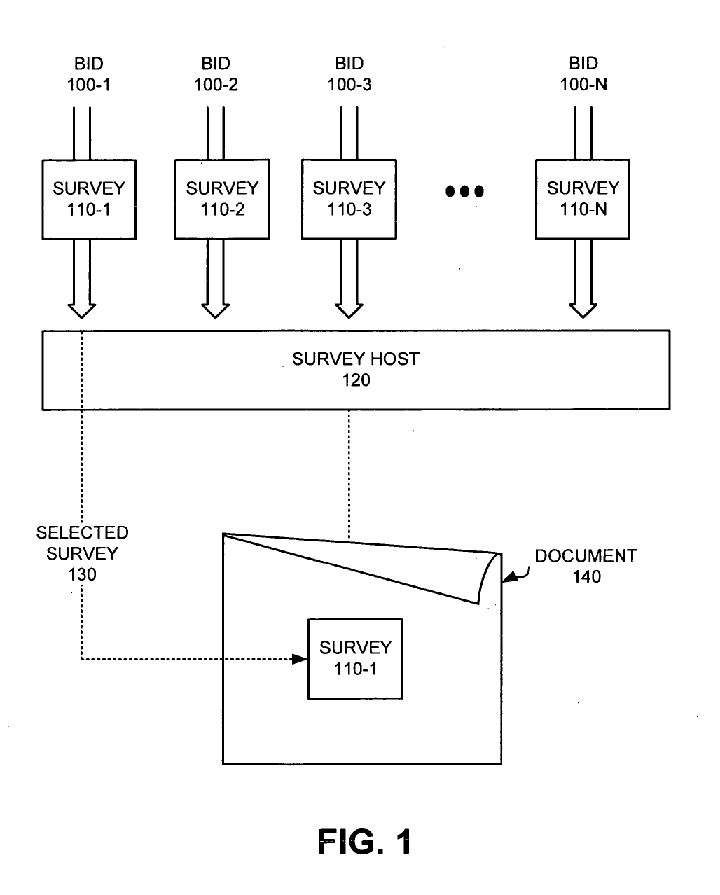

FIG. 1 illustrates an exemplary overview of a survey placement bidding process consistent with one implementation of the invention. As shown in FIG. 1, multiple bids 100-1 through 100-N, associated with respective surveys 110-1 through 110-N, may be received by a survey host 120. Each of bids 100-1 through 100-N may represent an amount of money that the bidder is willing to pay to have survey host 120 host a respective survey, and provide that survey to an interested user via a document. Survey host 120 may, thus, host multiple surveys received from multiple different entities.

Survey host 120 may, based on bids 100-1 through 100-n, select one or more surveys 130 from surveys 110-1 through 110-N, and associate the selected one or more surveys 130 with a document 140. As an illustrative example, FIG. 1 depicts a single survey 110-1 being selected by survey host 130 and being associated with document 140. In one implementation, association of selected survey 130 with document 140 may include inserting a content of the survey 130 in document 140. In another implementation, association of selected survey 130 with document 140 may include inserting a link into document 140 that includes a reference to another document that includes a content of the respective survey. Selected survey 130 may be associated with document 140 as a “zippy” box or a “pop-up” window. A “zippy” box may include an expanding area within a document (e.g., a web page) that rearranges the content of the page.

### Exemplary Network Configuration

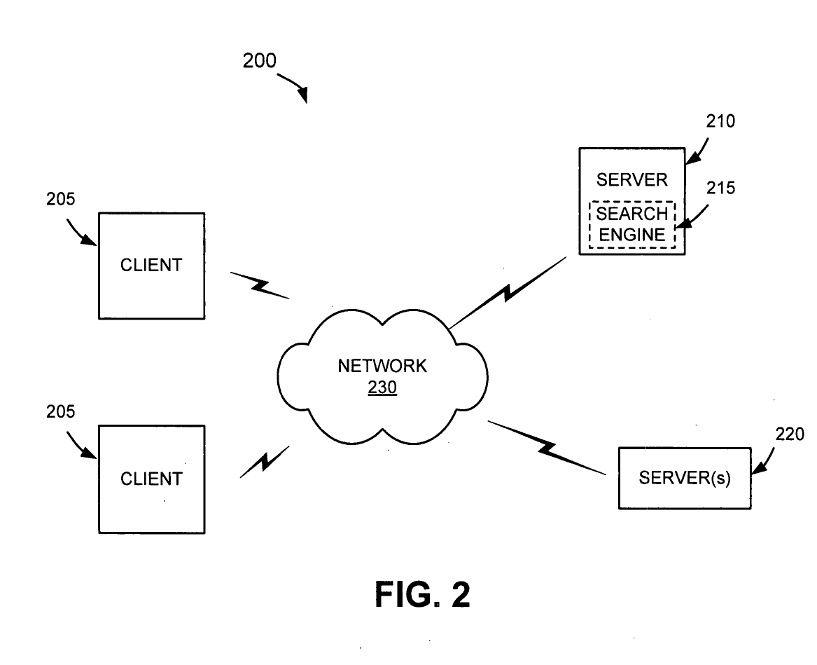

FIG. 2 is an exemplary diagram of a network 200 in which systems and methods consistent with the principles of the invention may be implemented. Network 200 may include multiple clients 205 connected to server 210 or server(s) 220 via a network 230. Two clients 205 and servers 210 and 220 have been illustrated as connected to network 230 for simplicity. In practice, there may be more or fewer clients and servers. Also, in some instances, a client may perform one or more functions of a server and a server may perform one or more functions of a client.

Clients 205 may include devices, such as a personal computer, a wireless telephone, a personal digital assistant (PDA), a lap top, or another type of computation or communication device, a thread or process running on one of these devices, and/or an object executable by one of these devices. Clients 205 may implement a browser for browsing documents stored at servers 210 or 220.

Server 210 may include a server entity that accesses, fetches, aggregates, processes, searches and/or maintains documents. In an implementation consistent with the principles of the invention, server 210 may include a search engine 215 usable by users at clients 205. Server 210 may implement a data aggregation service by crawling a corpus of documents hosted on server(s) 220, indexing the documents, and storing information associated with these documents in a repository of crawled documents. The aggregation service may be implemented in other ways, such as by agreement with the operator(s) of server(s) 220 to distribute their documents via the data aggregation service. Search engine 215 may execute a search using a query, received from a user at a client 205, on the corpus of documents stored in the repository of crawled documents. Server 210 may further receive survey placement bids, from clients 205, and may place hosted surveys in documents stored at server 210 or server(s) 220.

Server(s) 220 may store or maintain documents that may be browsed by clients 205. Such documents may include data related to published news stories, products, images, user groups, geographic areas, or any other type of data. For example, server(s) 220 may store or maintain news stories from any type of news source, such as, for example, the Washington Post, the New York Times, Time magazine, or Newsweek. As another example, server(s) 220 may store or maintain data related to specific products, such as product data provided by one or more product manufacturers. As yet another example, server(s) 220 may store or maintain data related to other types of web documents, such as pages of web sites. In some implementations, server(s) 220 may host surveys received from server 210 in documents that are accessible by users at clients 205.

While servers 210 and 220 are shown as separate entities, it may be possible for one of servers 210 or 220 to perform one or more of the functions of the other one of servers 210 or 220. For example, it may be possible that servers 210 and 220 can be implemented as a single server. It may also be possible for a single one of servers 210 and/or 220 to be implemented as two or more separate (and possibly distributed) devices.

Network 230 may include one or more networks of any type, including a local area network (LAN), a wide area network (WAN), a metropolitan area network (MAN), a telephone network, such as the Public Switched Telephone Network (PSTN) or a Public Land Mobile Network (PLMN), an intranet, the Internet, a memory device, or a combination of networks. The PLMN(s) may further include a packet-switched sub-network, such as, for example, General Packet Radio Service (GPRS), Cellular Digital Packet Data (CDPD), or Mobile IP sub-network.

### Exemplary Client/Server Architecture

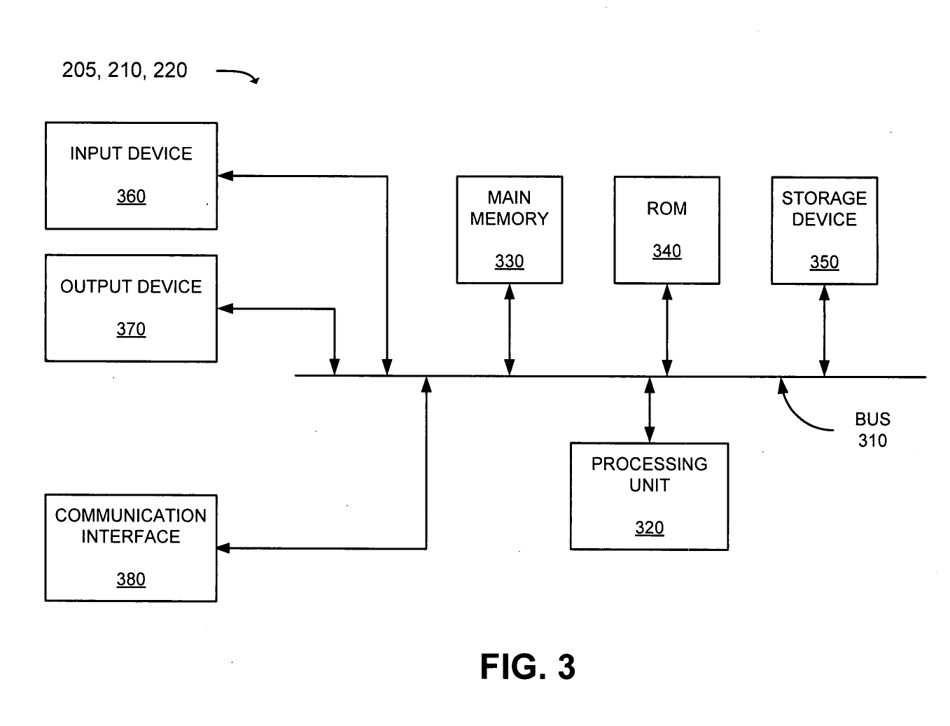

FIG. 3 is an exemplary diagram of a client or server entity (hereinafter called “client/server entity”), which may correspond to one or more of clients 205 and/or servers 210 and 220, according to an implementation consistent with the principles of the invention. The client/server entity may include a bus 310, a processor 320, a main memory 330, a read only memory (ROM) 340, a storage device 350, an input device 360, an output device 370, and a communication interface 380. Bus 310 may include a path that permits communication among the elements of the client/server entity.

Processor 320 may include a processor, microprocessor, or processing logic that may interpret and execute instructions. Main memory 330 may include a random access memory (RAM) or another type of dynamic storage device that may store information and instructions for execution by processor 320. ROM 340 may include a ROM device or another type of static storage device that may store static information and instructions for use by processor 320. Storage device 350 may include a magnetic and/or optical recording medium and its corresponding drive.

Input device 360 may include a mechanism that permits an operator to input information to the client/server entity, such as a keyboard, a mouse, a pen, voice recognition and/or biometric mechanisms, etc. Output device 370 may include a mechanism that outputs information to the operator, including a display, a printer, a speaker, etc. Communication interface 380 may include any transceiver-like mechanism that enables the client/server entity to communicate with other devices and/or systems. For example, communication interface 380 may include mechanisms for communicating with another device or system via a network, such as network 220.

The client/server entity, consistent with the principles of the invention, may perform certain operations or processes, as will be described in detail below. The client/server entity may perform these operations in response to processor 320 executing software instructions contained in a computer-readable medium, such as memory 330. A computer-readable medium may be defined as a physical or logical memory device and/or carrier wave.

The software instructions may be read into memory 330 from another computer-readable medium, such as data storage device 350, or from another device via communication interface 380. The software instructions contained in memory 330 may cause processor 320 to perform operations or processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

### Exemplary Survey Placement Bidding Process

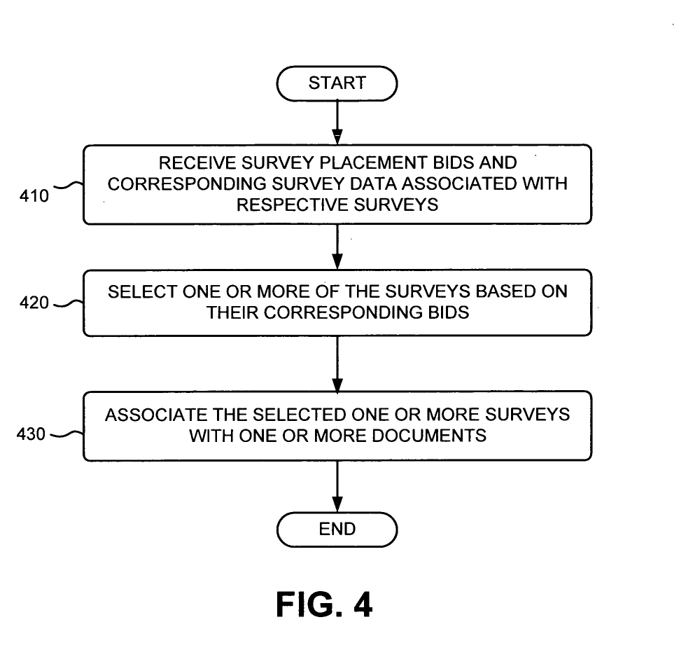

FIG. 4 is a flowchart of an exemplary process for associating surveys with documents based on survey placement bids consistent with principles of the invention. The process exemplified by FIG. 4 may, in some implementations, be implemented by server 210.

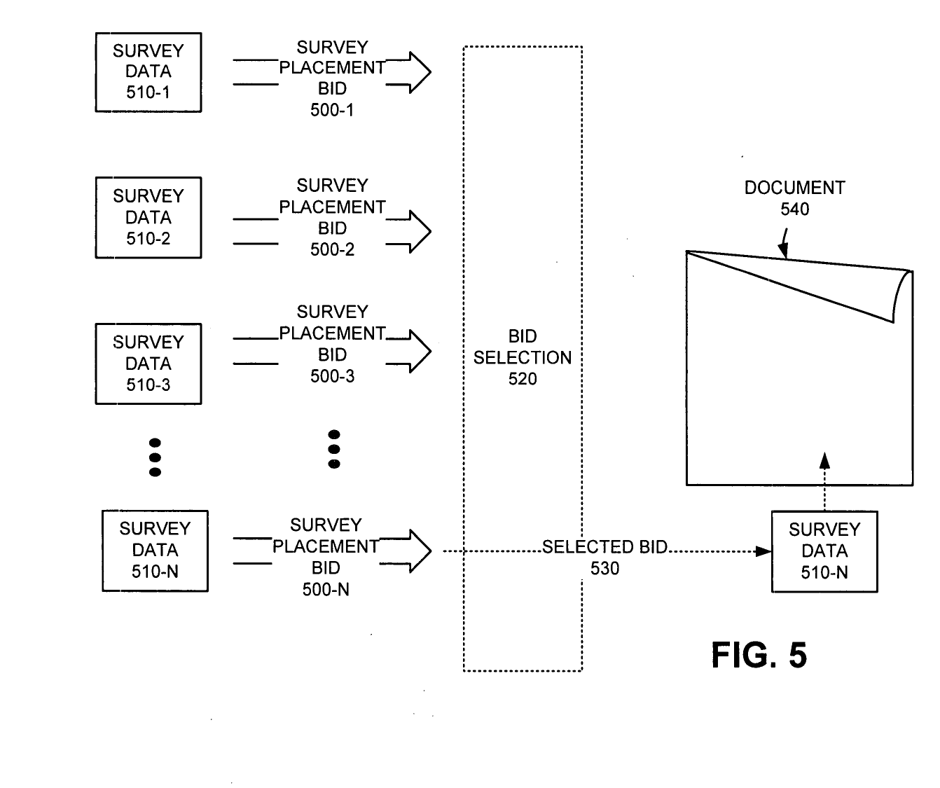

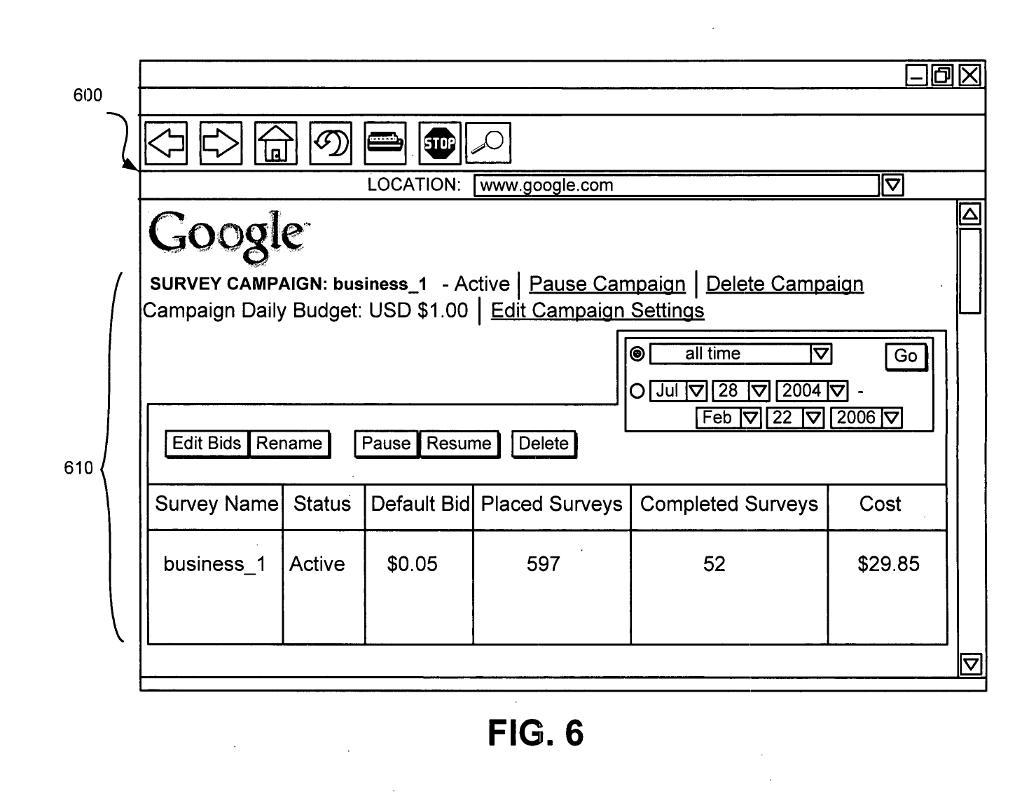

The exemplary process may begin with the receipt of survey placement bids and corresponding survey data (block 410). The survey placement bids and corresponding survey data may be received by server 210 via network 230 from a client 205. As shown in FIG. 5, survey placement bids 500-1 through 500-N, and corresponding survey data 510-1 through 510-N, may be received by server 210 for bid selection. Bids may be placed at a client 205 using, for example, a survey bidding document 600, as illustrated in FIG. 6. Survey bidding document 600 may include entry fields 610 that permit a user to enter one or more survey campaigns, each of which includes a bid for placement of a respective survey by server 210. Entry fields 610 may include, for example, a field for entering a name of a survey and a field for entering a bid amount. The survey placement bids may be placed as part of a separate survey auction or as part of an auction for placement of advertisements. The survey data associated with each survey placement bid may include survey questions.

One or more surveys may be selected based on their corresponding bids (block 420). Server 210, as the survey host, may select one or more surveys from the received surveys based on a bid amount associated with each of the surveys. For example, bids bid_1=$0.25, bid_2=$0.15 and bid_3=$0.20 may be received by server 210. Server 210 may select bid_1 for survey placement since it has the highest bid. FIG. 5 illustrates bid selection 520 in which a single bid 500-N is selected as the selected bid 530 for survey placement.

The selected one or more surveys may then be associated with one or more documents (block 430). The one or more documents may be hosted by server 210, or may be hosted by server(s) 220. In one implementation, association of the one or more selected surveys with one or more documents may include inserting content of each selected survey in a respective document. In another implementation, association of the one or more selected surveys with the one or more documents may include inserting a link into a document that includes a reference to another document that further includes the content of the respective survey. For example, as shown in FIG. 5, survey data 510-N, associated with the selected survey bid 500-N may be associated with document 540. In other implementations, the one or more selected surveys may be associated with the one or more documents as “zippy” boxes or “pop-up” windows.

### Exemplary Survey Placement Bidding Process

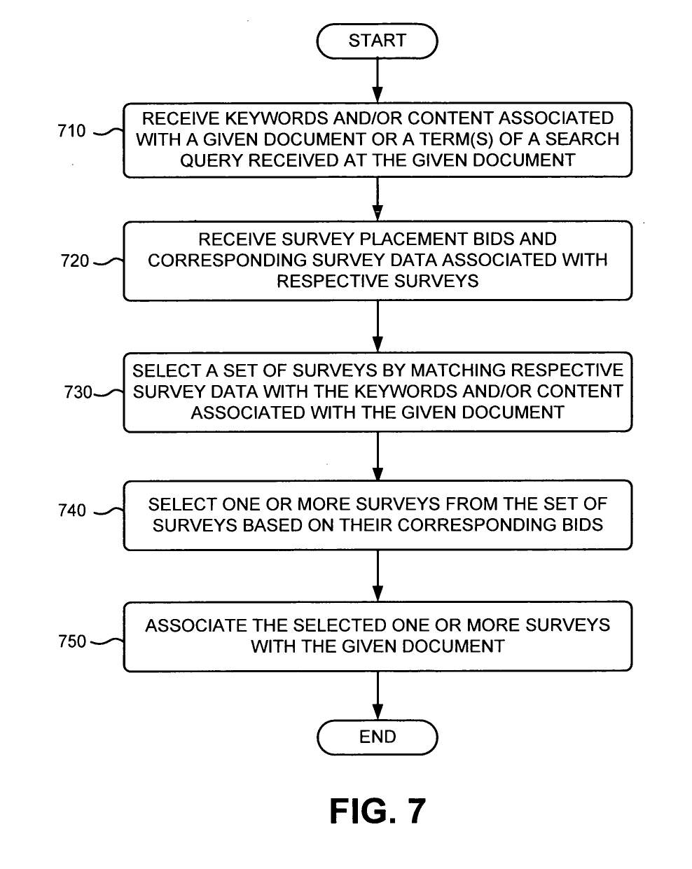

FIG. 7 is a flowchart of an exemplary process for associating surveys with documents based on survey placement bids and based on content of the respective surveys consistent with principles of the invention. The process exemplified by FIG. 7 may, in some implementations, be implemented by server 210.

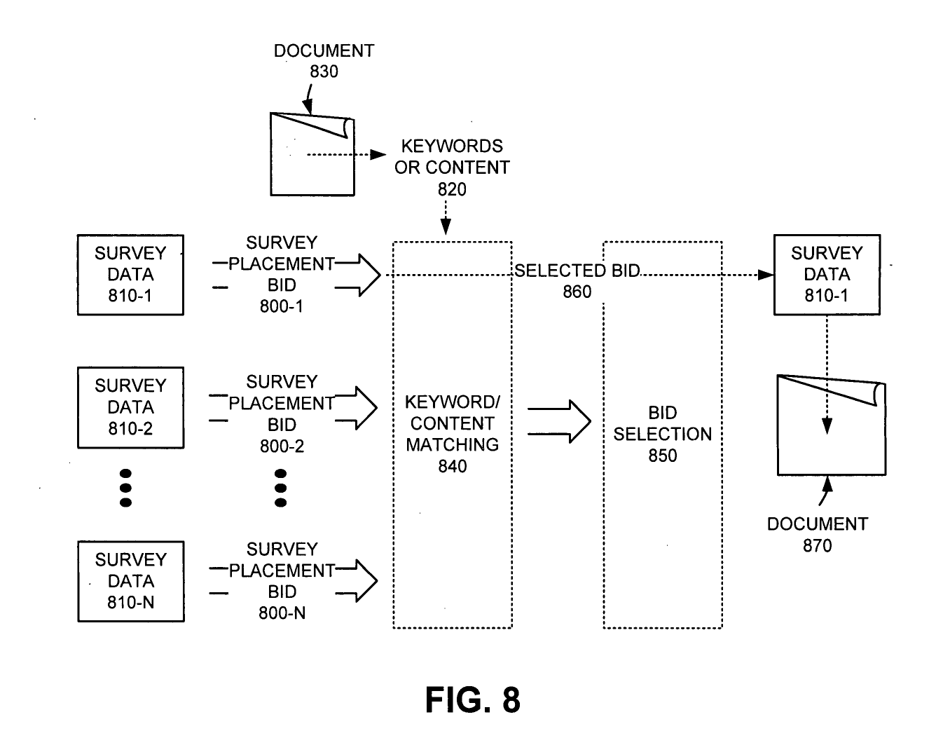

The exemplary process may begin with the receipt of keywords and/or content associated with a given document or a term(s) of a search query received at the given document (block 710). The content of the given document may include any text, images, or other type of data contained in the given document. The keywords and/or content may be provided by the entity that hosts the given document, or server 210 may “crawl” the given document to identify the keywords and/or content. The keywords may include one or more different words that label the given document, or which are representative of the content contained in the given document. FIG. 8 illustrates keywords or content 820 associated with a given document 830. The given document may be stored at server 210, or at server(s) 220. A user browsing the given document may enter a search query at the document (e.g., to perform a search) and one or more terms of the search query may be provided to server 210.

Survey placement bids and corresponding survey data associated with respective surveys may be received (block 720). The survey placement bids and corresponding survey data may be received by server 210 via network 230 from clients 205. As shown in FIG. 8, survey placement bids 800-1 through 800-N, and corresponding survey data 810-1 through 810-N, may be received for bid selection. Bids may be placed at clients 205 using, for example, survey bidding document 600 illustrated in FIG. 6. The survey placement bids may be placed as part of a separate survey auction or as part of an auction for placement of advertisements.

A set of surveys may be selected by matching respective survey data with the keywords and/or content associated with the given document (block 730). The survey data of respective surveys may be compared to the keywords and/or content associated with the given document to identify surveys having content that is the same or similar to the keywords and/or content of the given document. As shown in FIG. 8, keywords or content 820 can be used in the keyword/content matching process 840 to identify content in survey data 810-1 through 810-N that is the same or similar to keywords or content 820. The survey data associated with each selected survey may include survey questions that are related to the nature or content of the given document or to the terms of the search query.

One or more surveys from the set of surveys may be selected based on their corresponding bids (block 740). The bids of the selected set of surveys may be compared with one another to select one or more of the highest bids, possibly in conjunction with other criteria. As shown in FIG. 8, a bid selection process 850 may select a bid 860 from bids 800-1 through 800-N.

The selected one or more surveys may be associated with the given document (block 750). The given document may be hosted by server 210, or by server(s) 220. In one implementation, association of the selected one or more surveys with the given document may include inserting a content of each selected survey in the given document. In another implementation, association of the selected one or more with the given document may include inserting a link into the document that includes a reference to another document that further includes a content of a respective survey. As shown in FIG. 8, survey data 810-1, associated with the selected bid 860, may be associated with a document 870. In other implementations, the one or more selected surveys may be associated with the given document as a “zippy” box or a “pop-up” window.

### Exemplary Survey Placement Bidding Process

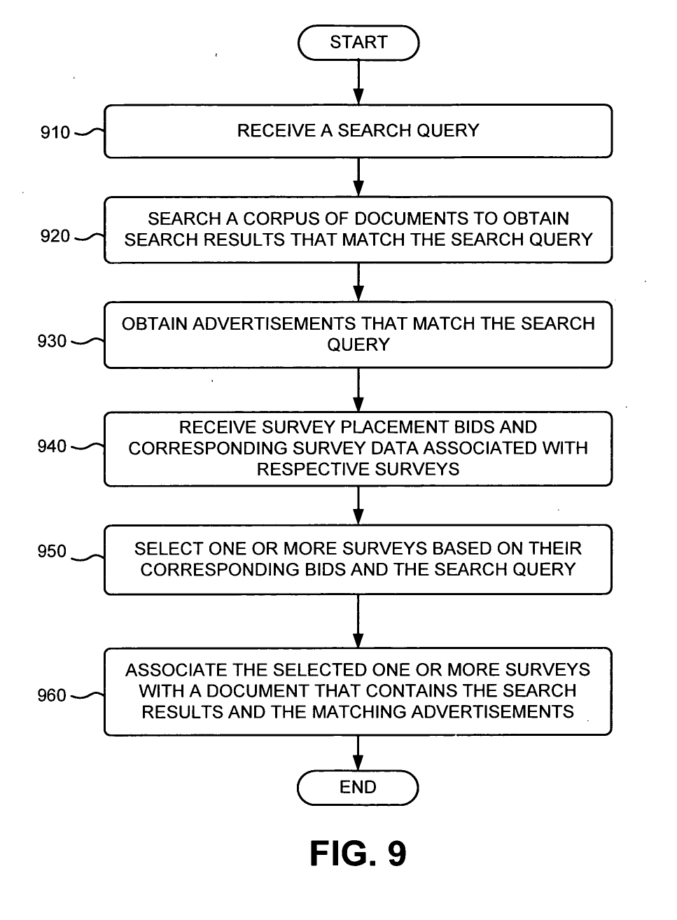

FIG. 9 is a flowchart of an exemplary process for associating surveys with documents that include search results and/or advertisements based on survey placement bids consistent with principles of the invention. The process exemplified by FIG. 7 may, in some implementations, be implemented by server 210.

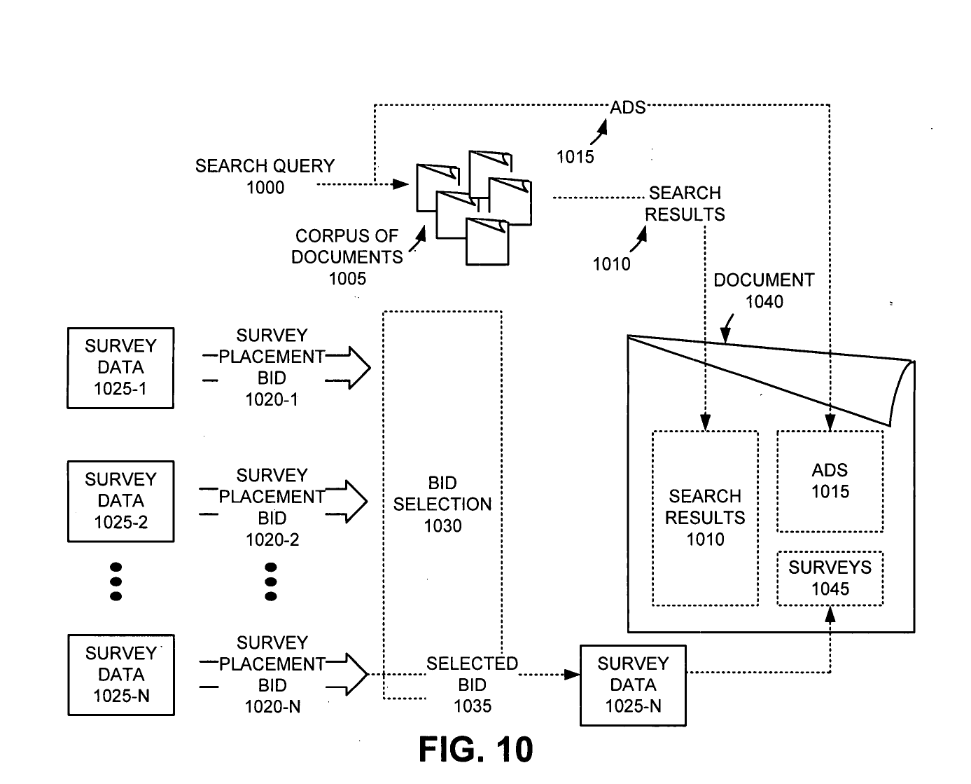

The exemplary process may begin with the receipt of a search query (block 910). The search query may be received at server 210 from a client 205. A corpus of documents may be searched to obtain search results that match the search query (block 920). Search engine 215 at server 210 may search a repository of crawled documents to obtain documents that have content that is the same or similar to the search query. As shown in FIG. 10, a search query 1000 may be used to search a corpus of documents 1005 to obtain search results 1010.

Advertisements may then be obtained that match the search query (block 930). Search engine 215 may search the repository of crawled documents, or a repository of advertisements, to obtain advertisements that have content that is the same or similar to the search query. As further shown in FIG. 10, ads 1015 may be obtained that match search query 1000.

Survey placement bids and corresponding survey data associated with respective surveys may be received (block 940). The survey placement bids and corresponding survey data may be received by server 210 via network 230 from clients 205. As shown in FIG. 10, survey placement bids 1020-1 through 1020-N, and corresponding survey data 1025-1 through 1025-N, may be received for bid selection. Bids may be placed at clients 205 using, for example, survey bidding document 600 illustrated in FIG. 6. The survey placement bids may be placed as part of a separate survey auction or as part of an auction for placement of advertisements.

One or more surveys may be selected based on their corresponding bids and the search query (block 950). The bids of the surveys may be compared with one another to select one or more of the highest bids, possibly in conjunction with other criteria. The one or more surveys may additionally be selected, in conjunction with bid comparison, by comparing the search query with survey data 1025-1 through 1025-N. The survey data associated with each selected survey may include survey questions that are related to the terms of the search query. As shown in the illustrative example of FIG. 10, a bid selection process 1030 may select a bid 1035 from bids 1020-1 through 1020-N.

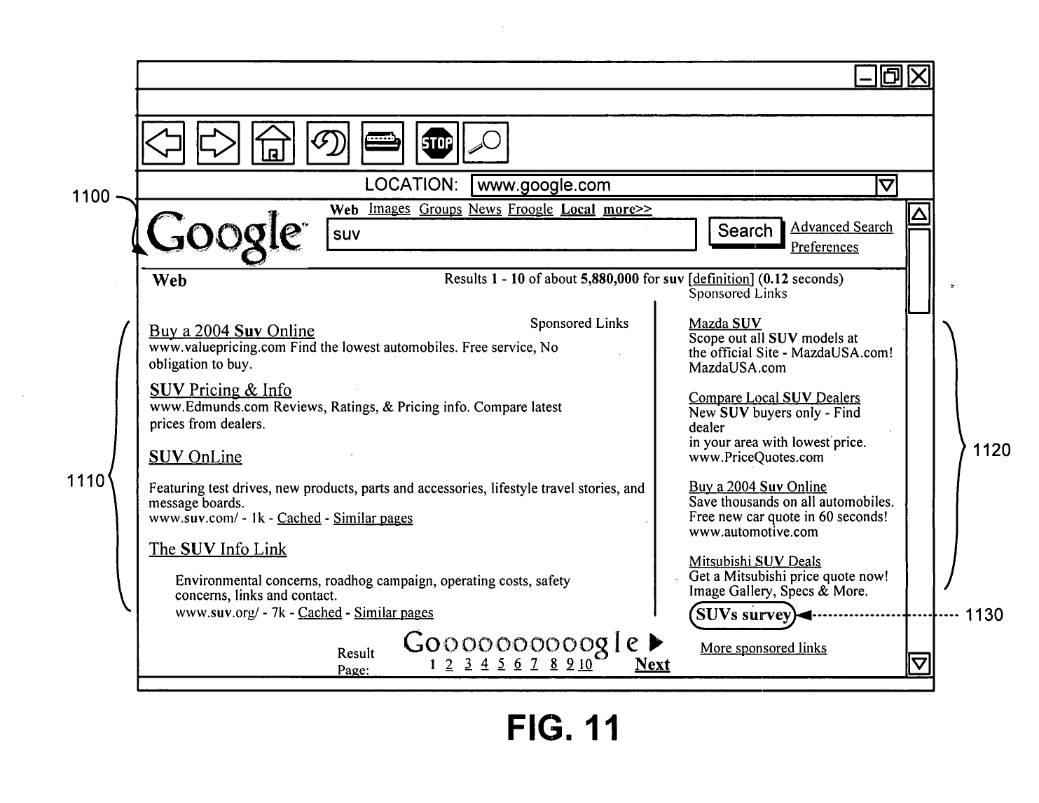

The selected one or more surveys may be associated with a document that contains the search results and the matching advertisements (block 960). Server 210 may construct a document that includes the search results and the matching advertisements and may provide the constructed document to a client 205 that issued the search query. In one implementation, association of the selected one or more surveys with the document may include inserting a content of each selected survey in the document. In another implementation, association of the selected one or more surveys with the document may include inserting a link into the document that includes a reference to another document that further includes a content of a respective survey. As shown in the illustrative example of FIG. 10, survey data 1025-N of selected bid 1035 may be associated with document 1040 that additionally includes search results 1010 and ads 1015. FIG. 11 depicts one example of a document 1100 that includes search results 1110, advertisements 1120, and a button 1130 associated with a link to a survey. A user may select button 1130 and the user's browser may be directed, using the link, to a document that contains the contents of the survey. In other implementations, the selected one or more surveys may be associated with the document as a “zippy” box or a “pop-up” window.

### Exemplary Survey Data Aggregation Process

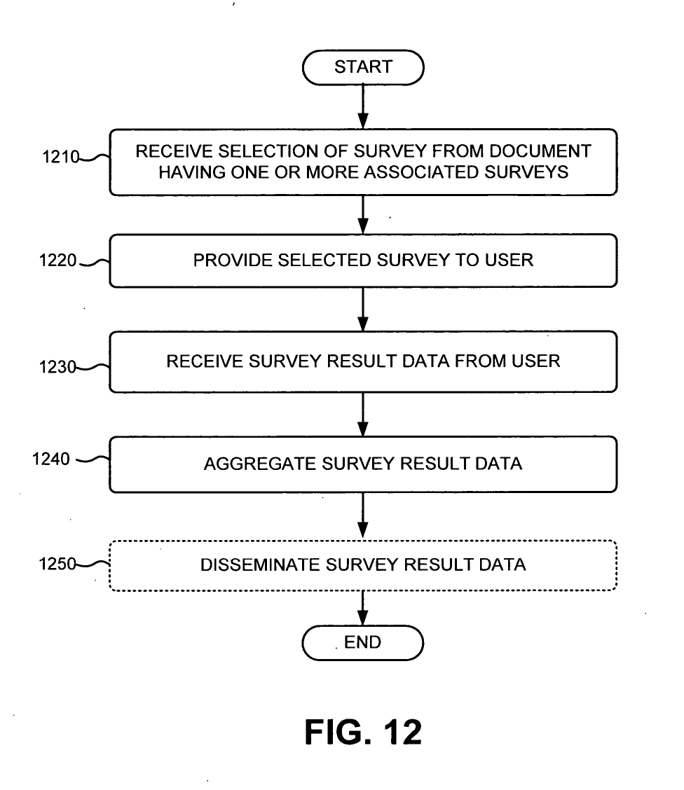

FIG. 12 is a flowchart of an exemplary process for providing hosted surveys to users and aggregating the results of those surveys consistent with principles of the invention. The process exemplified by FIG. 12 may, in some implementations, be implemented by server 210 and/or server 220.

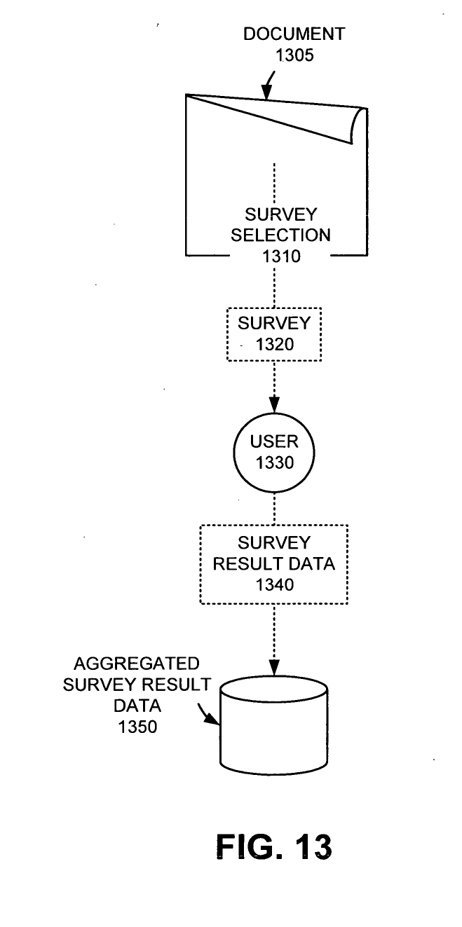

The exemplary process may begin with the receipt of a selection of a survey from a document having one or more associated surveys (block 1210). Server 210, or server 220, may provide a document to a user at a client 205 that includes, for example, a link to one or more surveys. The user at client 205 may, for example, select the link by “clicking” on it using a mouse. As shown in the illustrative example of FIG. 13, a survey selection 1310 may be received from a document 1305. The selected survey may be provided to the selecting user (block 1220). Server 210 may, for example, provide a document containing the selected survey to the user at client 205 via network 230. As shown in the illustrative example of FIG. 13, survey selection 1310 results in the provision of survey 1320 to a user 1330. The selected survey may, in some implementations, be provided to the selecting user as a “zippy” box or a “pop-up” window. In some implementations, the user or entity that bid for placement of the selected survey may be charged when the selected survey is provided to the selecting user.

Survey result data, received in response to the provision of the selected survey, may be received from the user (block 1230). After receiving the selected survey, the user at client 205 may provide answers to the questions of the survey, and the answers may returned to server 210 as survey result data via network 230. As illustrated in FIG. 13, survey result data 1340 may be received from user 1330. In certain implementations, the user or entity that bid for placement of the selected survey may be charged, in addition to, or instead of, the charge incurred when the selecting user selected the survey, when user answers to the survey are returned to the server. Additionally, in some implementations, a reward may be given to the user for filling in the survey. The reward may include, for example, a discount for purchasing services or products from the entity that placed the survey.

The received survey result data may be aggregated with previously received survey result data (block 1240). Server 210 may aggregate the received survey result data with previously received survey result data by storing it in a memory, such as, for example, in a database stored in a memory. Survey result data 1340 may, as illustrated in the illustrative example of FIG. 13, be aggregated with aggregated survey result data 1350.

The aggregated survey result data may then be selectively disseminated (optional bock 1250). Aggregated survey result data associated with a given survey may, for example, be disseminated to the user or entity that bid for placement of the survey.

### Exemplary Implementations

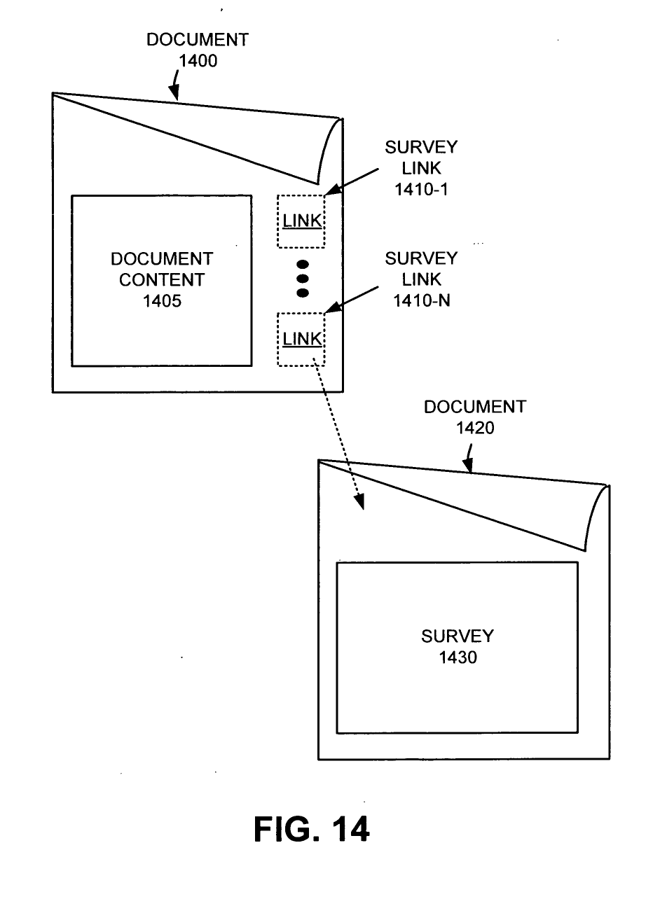

FIG. 14 is a diagram of an exemplary implementation in which links to documents containing a survey are placed in a document. In accordance with this implementation, a document 1400 may contain document content 1405 and one or more survey links 1410-1 through 1410-N. Each one of survey links 1410-1 through 1410-N includes a reference to another document 1420 that further includes the content of the associated survey 1430. By selecting a survey link 1410, a user's browser may be directed to document 1420 whose content includes survey 1430.

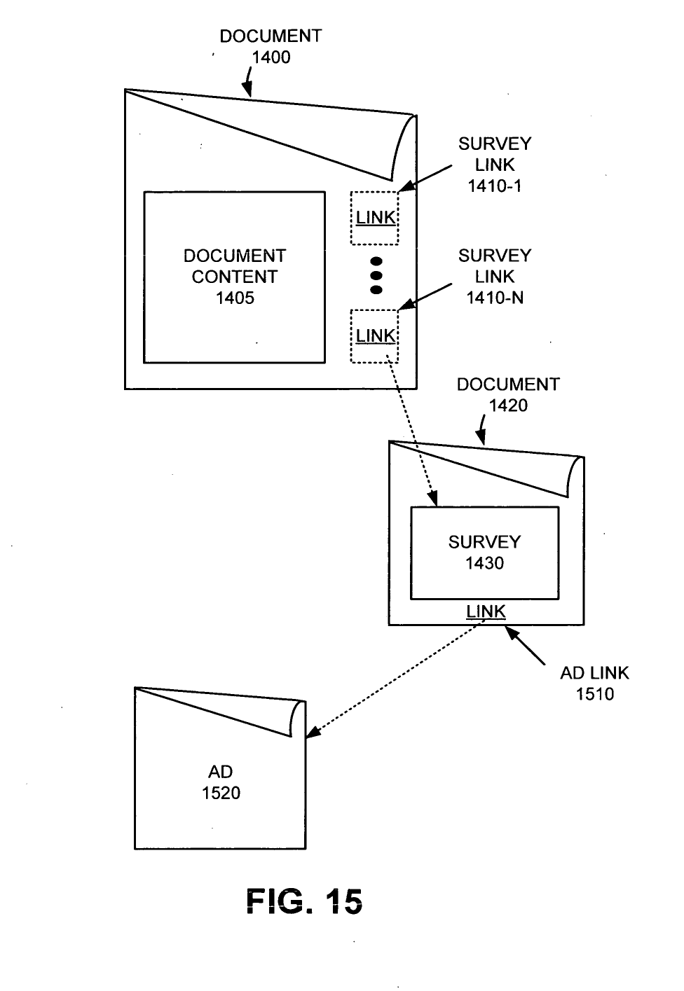

FIG. 15 is a diagram of an exemplary implementation in which a survey document includes a link to an associated advertiser. In accordance with this implementation, document 1420, as described with respect to FIG. 14, may include an ad link 1510. Ad link 1510 may include a reference to an ad document 1520. Thus, after responding to survey 1430, or instead of responding to survey 1430, a user may select ad link 1510 and the user's browser may be directed to ad document 1520.

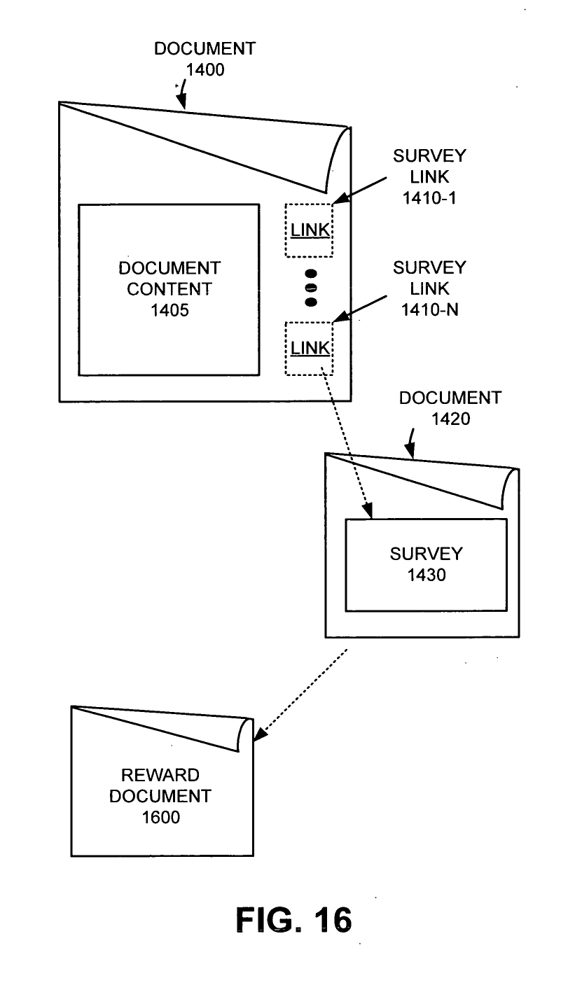

FIG. 16 is a diagram of an exemplary implementation in which a user is directed to a reward document from a survey document when the user completes the survey contained in the survey document. In accordance with this implementation, when a user responds to survey 1430 contained in document 1420, a reward document 1600 may be provided to the user. Reward document 1600 may include, for example, a discount for purchasing services or products from the entity that placed survey 1430.

### CONCLUSION

The foregoing description of implementations consistent with principles of the invention provides illustration and description, but is not intended to be exhaustive or to limit the invention to the precise form disclosed. Modifications and variations are possible in light of the above teachings, or may be acquired from practice of the invention. For example, while series of acts have been described with regard to FIGS. 4, 7, 9, and 12, the order of the acts may be modified in other implementations consistent with the principles of the invention. Further, non-dependent acts may be performed in parallel.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects have been described without reference to the specific software code, it being understood that one of ordinary skill in the art would be able to design software and control hardware to implement the aspects based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A computer-implemented method, comprising:
receiving bids associated with placement of respective surveys;
selecting one or more of the surveys based on their respective bids; and
associating the selected one or more surveys with documents hosted at one or more servers.

2. The computer-implemented method of claim 1, wherein associating the selected one or more surveys with the documents hosted at one or more servers comprises:
inserting the selected one or more surveys within the content of the documents.

3. The computer-implemented method of claim 1, wherein associating the selected one or more surveys with the documents hosted at one or more servers comprises:
inserting links to the selected one or more surveys within the documents.

4. The computer-implemented method of claim 1, wherein selecting one or more of the surveys based on their respective bids comprises:
selecting the one or more of the surveys that have the highest bids.

5. The computer-implemented method of claim 1, wherein the selected one or more surveys are associated with documents hosted at a server at which the bids are received.

6. The computer-implemented method of claim 1, wherein the selected one or more surveys are associated with documents hosted at a server that is different than a server at which the bids are received.

7. A method, comprising:
receiving keywords or content associated with a document;
receiving bids, and survey data, associated with placement of respective surveys;
selecting a set of the surveys by matching the survey data with the keywords or content associated with the document;
selecting one or more surveys from the set of surveys based on respective bids; and
associating the selected one or more surveys with the document.

8. The method of claim 7, wherein each survey of the selected one or more surveys includes survey questions that are related to the nature or content of the document.

9. The method of claim 7, wherein associating the selected one or more surveys with the document comprises:
inserting the selected one or more surveys within the content of the document.

10. The method of claim 7, wherein associating the selected one or more surveys with the document comprises:
inserting links to the selected one or more surveys within the document.

11. The method of claim 7, wherein selecting one or more of the surveys from the set of surveys based on respective bids comprises:
selecting the one or more of the surveys from the set of surveys that have the highest bids.

12. A method, comprising:
receiving a search query;
obtaining advertisements that match the search query;
receiving bids associated with placement of surveys;
selecting one or more of the surveys based on their respective bids and the search query;
associating the selected one or more surveys with a document that includes the advertisements.

13. The method of claim 12, further comprising:
executing a search of a corpus of documents using the search query to obtain search results;
inserting the search results in the document.

14. The method of claim 12, wherein associating the selected one or more surveys with the document comprises:
inserting the selected one or more surveys within the content of the document.

15. The method of claim 12, wherein associating the selected one or more surveys with the document comprises:
inserting links to the selected one or more surveys within the document.

16. The method of claim 12, wherein selecting one or more of the surveys based on respective bids comprises:
selecting the one or more of the surveys that have the highest bids.

17. A method, comprising:
hosting a plurality of surveys at a server from a plurality of different entities;
providing one or more of the surveys to users via a network;
receiving survey result data from the users via the network; and
aggregating the survey result data.

18. The method of claim 17, further comprising:
selectively disseminating the survey result data.

19. The method of claim 18, wherein selectively disseminating the survey result data comprises:
disseminating data of the survey result data to an entity of the plurality of different entities from which a respective survey originated.

20. The method of claim 17, wherein aggregating the survey result data comprises:
storing the survey result data with previously received survey result data.

21. A system, comprising:
a communication interface to receive bids associated with placement of respective surveys;
a processing unit to:
select one or more of the surveys based on their respective bids, and
associate the selected one or more surveys with documents hosted at one or more servers.

22. A system, comprising:
means for receiving bids associated with placement of respective surveys;
means for selecting one or more of the surveys based on their respective bids; and
means for inserting links to the selected one or more surveys within documents hosted at one or more servers.

23. A computer-readable medium that stores computer-executable instructions, comprising:
instructions for receiving bids associated with placement of respective surveys;
instructions for selecting one or more of the surveys based on their respective bids; and
instructions for associating the selected one or more surveys with documents hosted at one or more servers.
